(19) United States
(12) Patent Application Publication
(10) Pub. No.: US 2026/0045855 A1
(43) Pub. Date: Feb. 12, 2026

(54) Micro-Combined Heat and Power System and Method of Use

(71) Applicant: Axiom Energy Group, LLC, East Troy, WI (US)

(72) Inventors: Michael Schildt, Eagle, WI (US); Mario Di Benedetto, Big Bend, WI (US)

(21) Appl. No.: 19/293,555

(22) Filed: Aug. 7, 2025

Related U.S. Application Data
(60) Provisional application No. 63/681,459, filed on Aug. 9, 2024.

(51) Int. Cl. H02K 9/19; F24D 18/00; F24D 101/70; F24D 103/13; F24D 103/17; H02J 1/02; H02K 7/20; H02K 47/04; H02P 9/04; H02P 9/08

(52) U.S. Cl. CPC H02K 9/19; F24D 18/00; H02J 1/02; H02K 7/20; H02K 47/04; H02P 9/04; H02P 9/08; F24D 2101/70; F24D 2103/13; F24D 2103/17; F24D 2200/26; F24D 2220/0207; H02J 2310/12; H02P 2209/11

(57) ABSTRACT

A grid-independent micro-combined heat and power system supplies heat and electricity to a building or a small number of buildings and can operate completely independently of a central-type electrical power grid. The system includes a variable speed liquid-cooled engine and a liquid-cooled generator that is configured to output an electrical supply of between approximately between 0.5 kW and 40 kW, a coolant loop, and a water circuit. The coolant loop heats a liquid using claimed heat from the genset to heat water that can be utilized as a domestic hot water source for cooking or cleaning or for a hot water source for heating. The speed of the engine may be controlled to control the output of the genset to meet prevailing electrical loads. The system may be part of a microgrid incorporating several such systems that are in electrical communication with one another and that collectively supply electrical power and heat to from a few buildings to about one hundred buildings.

### CROSS-REFERENCE TO RELATED APPLICATIONS

This application claims the benefit of the provisional patent application U.S. App. No. 63/681,459 filed on August 9, 202 and entitled “Micro-Combined Heat and Power System and Method of Use,” the entire contents of which are hereby expressly incorporated by reference into the present application.

### FIELD OF THE INVENTION

The invention relates to the field of micro-combined heat and power systems (“mCHPs”) and, more particularly, relates to a long-life mCHP system that captures heat from multiple sources including a liquid cooled generator and is well-suited for use independent of an established electrical supply grid. The invention additionally relates to a method of using such a mCHP system.

### BACKGROUND OF THE INVENTION

Electricity generated at a traditional power plant and then transmitted over a power grid is lost in some parts of the world at a rate of nearly 70% by the time the electricity reaches its destination. The United States alone lost approximately 69 trillion BTU worth of power in 2013. In addition to the costs required to develop and maintain the required infrastructure to facilitate long distance electricity transmission, such transmission is neither feasible nor practical in many parts of world because these remote locations are positioned at distances too great from power sources and from each other for the economical transmission of power to them. This problem is particularly prevalent in impoverished regions globally. Without electricity, such regions cannot serve basic human needs, let alone establish any appreciable level of economic activity.

By way of example, in Nigeria, Africa's largest population and highest GDP, over 90 million people lack access to electricity. Without electricity, they lack basic necessities such as lighting or even the ability to drill for water. Nigeria, however, does have a very sophisticated natural gas and propane distribution system, which may be utilized as fuel in combined heat and power systems (“CHP”) or cogeneration systems, which combine the concurrent production of electrical power and thermal energy, i.e., heat, from a common source of energy. Such systems typically include a prime mover, such as an internal combustion engine, an electrical generator that is driven by the engine, and a heat recovery system which recovers heat generated by the engine and/or generator. Cogeneration allows for a more efficient use of fuel through the recapture of thermal energy which otherwise would be discarded as waste biproduct of the engine operation

With such abundant fuel source, a need exists for a micro-combined heat and power systems (“mCHP”), which can be located anywhere, no matter how remote or distant from any other developed infrastructure. With the heat that is generated to produce both a constant source of potable hot water, and hot water for use in heating applications, electricity is also simultaneously generated. The generation of electricity allows for both basic uses such light and water well pumps but also lays the foundation for advanced uses built off of the presence of reliable electricity, such as: hospitals, schools, and enhanced economic activity in the form of stores and markets. Electricity is also requisite for advanced communication systems, such as internet access, and improved living conditions brought through air conditioning, refrigeration, advanced plumbing systems and sanitation. As the overall quality of life improves through the availability of electricity and the enhancements built thereon, economic activity and further financial investment will follow, precipitating greater gender equality as women begin entering the workforce rather than simply being relegated to protecting their children in isolated conditions. It is anticipated that this scenario would play out all over the world, in those remote areas that currently lack access to dependable electricity. It is estimated that over 1.2 billion people currently lack access to electricity. And while it is not surprising that this impact is felt amongst the poorest nations, many developed countries such as India account for millions of people who also lack access to electricity.

Traditional CHP systems often are installed in applications that require a substantial electrical demand, such as industrial applications, large office buildings, hotels, multi-unit housing, etc. In such applications, the traditional CHP system is integrated into the existing electrical supply grid, where operation of the CHP resulting in the generation of electricity that exceeds local demand may be sold back into the electrical grid. However, such traditional CHP units are not well configured for smaller applications that require electrical generation of less than 5 kW due to their size and cost.

In contrast, mCHP systems, which typically generate less than 5 kW, are well-suited for use in such applications, such a single-family home, a small business, or a relatively small network of the same. However, much like their larger counterpart, mCHP systems are traditionally installed with a connection to an existing electrical grid. Integration into the existing electrical grid is generally thought to provide a source of revenue for mCHIP owners who can sell power to the power companies when supply exceeds demand. Grid access also provides electric current for use when starting the mCHP engine and a as back-up electrical source were the mCHP to fail. However, mCHP systems require electrical grid integration are inherently limited as to where they may be installed and are poorly suited for use in remote regions. Accordingly, it would be advantageous to have a mCHP system that is grid-independent and is not limited as to where it can be geographically installed.

Additionally, traditional CHP and mCHP systems are not configured to maximize their capture of thermal energy which would otherwise be discarded as waste biproduct of the engine operation. Accordingly, it would be further advantageous to have a mCHP system that is configured to capture thermal energy which would otherwise be discarded as waste biproduct of the engine operation from multiple sources, such as: exhaust heat, engine coolant and engine oil.

Furthermore, to facilitate true off-grid optimization if would be further advantageous to have a mCHP system that includes an alternator that provides integrated battery charging to power an engine starting battery, load sensing to optimize engine efficiency and/or 240V output optimization.

The need therefore exists to provide a long-life mCHP system that maximizes thermal energy recapture for use in off-grid installations while minimizing the occurrence of routine maintenance.

### SUMMARY OF THE INVENTION

In accordance with a first aspect of the invention, a gird independent mCHP system for a building or a small group of buildings may include a genset formed of a liquid cooled variable speed engine and a liquid cooled generator that may comprise an alternator configured to output an electrical supply of between approximately between 0.5 kW and 5.0 kw, and more typically between 1.2 kW and 4.4 kW, a coolant loop, and a water circuit. In one configuration, a coolant loop includes a recuperator that reclaims heat from both the engine and the generator A coolant-to-water heat exchanger, disposed downstream of the recuperator, cools the coolant back to approximately its first temperature while heating water in the water circuit. Heated water from the circuit may be used as a direct or indirect heat source for the services building(s) and/or as a source of potable domestic water. The system can operate completely independently of a “central” electrical power grid of the type supplying electricity to a large area, such as a region or country.

In addition, the mCHP may comprise a variable speed engine. The engine may be modulatable between a running speed or operating speed of approximately 500 RPM and 5,000 RPM and, more typically, 1,200 RPM to 3,400 RPM.

In addition, between 5,000 and 50,000, and, more typically, between 13,000 and 43,000 BTUs, may be transferred to the water in the coolant-to-water heat exchanger.

In addition, the mCHP system may regulate engine speed to generate an electrical output that matches an electrical load placed on the system by the serviced building(s).

The system may be part of a microgrid formed from several such systems in communication with one another and supplying heat and power to from a few buildings to about 100 buildings.

In addition, the mCHP system may comprise a battery-powered starting system for starting the genset's engine.

Also disclosed is a method of operating such a mCHP system.

These and other aspects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof. It is hereby disclosed that the invention includes all such modifications.

### BRIEF DESCRIPTION OF THE DRAWINGS

Preferred exemplary embodiments of the invention are illustrated in the accompanying drawing in which:

FIG. 1 is a box diagram of a mCHP system constructed in accordance with one embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION

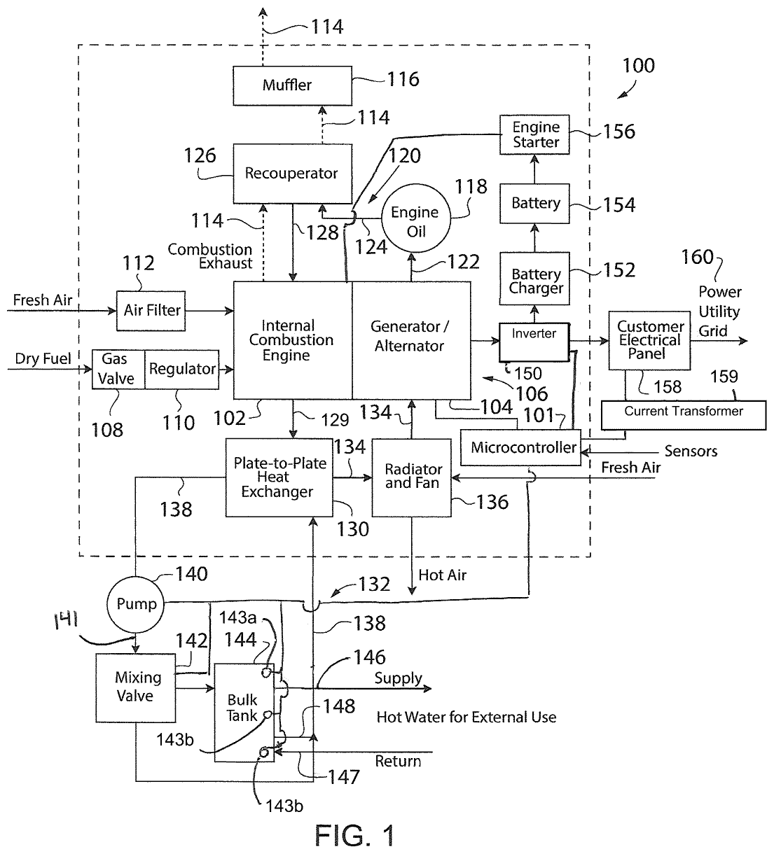

Referring to FIG. 1, a micro-combined heat and power (“mCHP”) system 100 constructed in accordance with one embodiment of the present invention is shown in schematic form. System 100 can be located off-grid, i.e., it need not be connected to an electrical power grid. The mCHP 100 comprises a generator set or “genset” 106 including an engine 102 and a generator 104. System 100 also includes a coolant loop 120 configured to progressively heat coolant by heat exchange from the engine 102, the genset's oil supply system, and the engine's exhaust system. A liquid-to-liquid heat exchanger 130 is provided for transferring heat from the hot coolant to water that may be used for domestic hot water and/or as a source of heat. Electricity generated by the system 100 can be used to directly satisfy the building(s) energy load(s), charge a battery used to power an electrically powered starter motor for the system's engine, and/or be stored for future use and/or fed into an electrical power grid, if one is present. System operation is controlled by programmable microcontroller 101, wherein signal wires in communication with the microcontroller 101 and components of the system 100 are shown without arrows throughout FIG. 1.

As is typical, the genset 106 includes an engine 102 and a generator/alternator 104. The engine 102 which is preferably an internal combustion engine but may be any alternative form of prime mover. The engine 102 may be a single-cylinder, approximately 8-HP internal combustion dual-fuel engine that is configured to run on either natural gas or propane without requiring mechanical modification to switch between fuels. Both of these fuels are widely available, including in regions lacking reliable electric power grids. Alternatively, the engine 102 may also be a single fuel engine and/or configured to run on any of a variety of fuels such as gasoline, diesel fuel, kerosene, biofuel, etc. More preferably, the engine 102 is configured to have a long-running lifespan of greater than approximately 40,000 operating hours and has relatively low maintenance requirements, with maintenance intervals of approximately 4,000 hours. Such a long-term run life and relatively infrequent maintenance is due in part to its use of both a liquid cooled engine 102 and a liquid cooled alternator 104, which is of significant importance in geographically remote applications of the mCHP system 100, where routine service may be unavailable.

The engine 102 may be a variable speed engine. Accordingly, modulating the running speed of the engine 102 between approximately 1,200 RPM to 3,400 RPM results in a corresponding electrical power generation of approximately between 1.2 kW and 4.4 kW, respectively. As a result of modulating the speed of the engine 102 under direct or indirect control of the microcontroller 101, the genset's electrical output can be varied to meet or follow the electrical load placed on the mCHP system 100, thereby maximizing efficiency of the system 100 as compared to a traditional fixed speed engine having a 2 pole or 4 pole alternator.

Operation of the engine 102 between approximately 1,200 RPM to 3,400 RPM to drive the alternator 104 to generate approximately between 1.2 kW and 4.4 kW may result in between 5,000 and 50,000, and, more typically, between 13,000 and 43,000 BTUs of waste heat reclaimed and transferred to the water loop 132, as described below. However, it should be considered to be well within the scope of the present invention that the engine and the genset as a whole may be of larger capacity such that the reclaimed heat output from the internal combustion engine 102 may further provide approximately: 51,000 to 100,000 BTU of heat when the genset 106 is configured to output approximately 10 kW of electricity; 101,000 to 150,000 BTUs of heat when outputting approximately 15kW of electricity; 151,000 to 200,000 BTU of heat when outputting approximately 20 kW; 201,000 to 250,000 BTU of heat when outputting approximately 25 kW of electricity; 251,000 to 300,000 BTU of heat when outputting approximately 30 kW of electricity; 301,000 to 350,000 BTU of heat when outputting approximately 35 kW of heat; and, 351,000 to 400,000 BTU when outputting approximately 40 kW of electricity.

Fuel is supplied to the engine 102 via a gas valve 108 and regulator 110, which controls the flow of fuel into the engine 102. Atmospheric air is supplied to the engine 102 through an air filter 112 at a variable rate that is typically of approximately 15 to 20 cubic feet per minute, depending upon engine speed. Heated exhaust gases exit the engine 102 through an exhaust system 114, which may have a muffler 116 disposed therein.

In one embodiment, the engine 102 may consistently operate with its throttle (not shown), positioned downstream of the air filter 112 and upstream of the engine 102, in a fully opened position. As a result of this operating condition, the throttle does not act as a restriction to the air flow into the engine cylinder, which thereby allows the engine 102 to maximize its volumetric efficiency and reduce emission output through the exhaust system 114. In such a system 100, the electrical output from the mCHP 100 is controlled by the inverter 104 which may be configured to match the electrical load placed on the system 100 and/or divert electrical power in excess of the electrical load to a storage system as will be described in further detail below.

During operation, the engine 102 is lubricated via engine oil delivered from an oil reservoir 118 and circulated between the engine 102 and the oil reservoir 118 via a pump (not shown). A coolant loop 120, comprising a series of conduits, extends from the engine 102 and alternator 104 as to allow coolant to flow throughout the mCHP system 100, thereby reducing the operating temperature of the engine 102 and alternator 104 and simultaneously recapturing waste heat for heating a water source as will be described in further detail below. More specially, in the coolant loop 120, coolant enters the alternator 104 at a first temperature of, for example, 148° F. Operation of the alternator 104 heats the coolant to a second temperature. The coolant then flows from an outlet 122 of alternator 104 to the oil reservoir 118. Heat from the engine oil contained within the reservoir 118 is transferred to the coolant via a liquid-to-liquid heat exchanger, i.e, oil cooler, thereby heating the coolant to a third temperature. This heat transfer reduces the temperature of the engine oil in the oil reservoir 118. Meanwhile, the heated coolant passes from the oil reservoir 118 via a conduit 124 and flows into a gas-to-liquid heat exchanger such as a thermal recuperator 126. The recuperator 126 may be a shell and tube exchanger comprising a liquid coolant filled shell containing a series of tubes through which the heated exhaust may travel. However, alternative heat exchanger configurations are within the scope of the present invention.

During use, the heated exhaust traveling from the engine 102 to the muffler 116 and through the exhaust outlet 114 passes through the tubes of the recuperator 126, heating the coolant flowing through the surrounding shell component to a fourth temperature.

An exhaust catalyst for reducing emissions in the exhaust may also be disposed at or in the recuperator 126 or elsewhere in the exhaust system, along with an oxygen sensor (not shown) that provides data used by the microcontroller 101 for controlling the fuel-to-air ratio of the engine 102. In this configuration, the recuperator 126 may also contain a catalytic converter or other exhaust treatment device as to reduce toxic gases and pollutants in the exhaust gas prior to entering the muffler 116.

The coolant at the fourth temperature then flows from the recuperator 126, through conduit 128, to the engine 102. Operation of the engine 102 further heats the coolant to a fifth temperature, typically, approximately 155° F. to 175° F., and more preferably approximately 168° F. A water pump (not shown), attached to or part of the engine 102, continues to circulate the coolant through coolant loop 120 as generally described above. Upon exiting the engine 102, the heated coolant travels via conduit 129 to a coolant-to-water heat exchanger 130. In one embodiment of the present invention, the heat exchanger 130 is a plate-to-plate exchanger. However, other exchangers such as shell and tube, plate and fin, and microchannel exchangers are well within the scope of the present embodiment. At the exchanger 130, heat from the coolant, is transferred to water flowing through a water circuit 132, thereby heating the water flowing through the water circuit 132 and cooling the coolant by approximately 15° F. to 25° F., and more preferably approximately 20° F. In one embodiment, the heated coolant enters the heat exchanger 130 at a temperature of approximately 168° F. and exits the heat exchanger 130 at a lower temperature of approximately between 148° F. The coolant may then return to the alternator 104 of the genset 106 via coolant inlet 134, thereby completing and then restarting the coolant loop 120.

Though by no means critical to the system, a radiator and fan assembly 136 may be disposed in line with the coolant inlet 134, as shown in FIG. 1. In the event that the heat transfer at the exchanger 130 is insufficient to reduce the temperature of the coolant to a temperature at or near the first temperature, additional excess heat may be removed from the coolant via the radiator and fan assembly 136 that passes atmospheric air through the radiator 136 to dissipate excess heat. The fan of the assembly 136 need not be continually activated but rather can be selectively activated in response to the temperature of the coolant output from the exchanger 130 sufficiently exceeding the first temperature.

Referring again to FIG. 1, a water loop system 132 is provided for heating the water from the coolant loop 120, and storing the heated water at a temperature set to meet the hot water needs of a building at which system 100 is installed. The water loop 132 includes a water pump 140, which is controlled by the microcontroller 101. The water pump 140 pumps water through the water loop 132. In so doing, water is supplied from a bulk hot water storage tank 144 through a conduit 138 and into an inlet 141 of mixing valve 142. The microcontroller 101 controls the mixing valve 142 to regulate the output temperature of the water that exits the plate-to-plate heat exchanger 130 and reenters the tank 144, and/or regulate the operating temperature of the coolant exiting plate-to-plate heat exchanger 130. The tank 144 may be a bulk storage tank of any desired capacity to meet hot water supply needs. Water in the tank may be used, for example, for domestic hot water, heating applications, etc. The tank 144 may include an outlet 146 to supply hot water from the tank 144 upon demand and an inlet 147 to return and/or mix relatively lower temperature water back into the tank 144. In one embodiment, the outlet 146 and inlet 147 may be opposing ends of a common fluid conduit, for example in a hydronic heating system, such that the water circuit 132 forms a recirculating closed loop. Alternatively, the outlet 146 may supply hot water to faucets, appliances, etc., which operate independent of the inlet 147, such that the inlet 147 independently directs newly supplied and previously unheated water into the tank 144. Both types of inlet may well be provided in the same or common tank 144. In any event, the tank 144 may include therein one or more water temperature sensors 143. For example, as shown in FIG. 1, three vertically spaced sensors 143a, 143b, 143c may provide various temperature readings at distinct depths in the tank 144 and be used to maintain a target temperature within the tank 144. In one embodiment, the target temperature may be between preferably 120° F. to 160° F. The desired temperature of water in the tank 144 may be maintained by way of regulating flow of heated water supplied from the conduit 138 through mixing valve 142 and/or returning excess water from the tank 144 back to the conduit 138, via an outlet 148, which then returns to the plate-to-plate heat exchanger 130 to be reheated in completing the water circuit 132, as controlled by the microcontroller 101.

In yet another alternative embodiment of the present invention, not shown, a valve (not shown) upstream of the tank inlet, may divert heated water from the conduit 138 directly to an end use location, such as a faucet, or appliance, without first entering tank 144. In such an embodiment, the water circuit 132 provides on-demand hot water directly from the mixing valve 142.

In still another alternative embodiments of the present invention, not shown, the water circuit 132 may constitute a closed-loop including an additional water-to-water heat exchanger (not shown) in line with conduit 138, such that heat in the water flowing through the conduit 138 is transferred to an independent secondary water supply without interrupting the flow of water through the water circuit 132.

Returning now to the genset 106, as was described above, operation of the engine 102 generates rotational mechanical energy to power generator/alternator 104 to generate an AC electric current. As illustrated in FIG. 1, the AC current from the generator/alternator 104 is transmitted through an electrical conductor to an inverter 150, where the alternating current is converted to direct current. A first portion of the current is directed through a battery charger 152, which in turn charges a starter battery 154, such as a 12V battery. In a preferred embodiment, the battery charger 152 is an integral component of the inverted 150. Upon initial start-up of the mCHP system 100, the battery 154 supplies power to an electric engine starter 156, which cranks the engine 102 so as to initiate operation of the engine 102 under its own power. More specifically, a battery boost converter or DC-to-DC step-up converter integral with the inverted creates 60V DC from the 12V battery 152 for use in engine starting. By providing an electric starter that is charged through operation of the genset 106, the mCHP 100 does not need to rely upon a central power grid or other external power source in order to start the mCHP system 100. Accordingly, the mCHP system 100 according to the present invention is well-suited for operation in geographic regions that lack either a central power grid or a dependable electrical distribution network.

Furthermore, according to the present invention, inverter 150 converts high voltage DC output from the generator 102 to 240V AC power, and more specifically a 240/120V AC split phase electrical power for use in standalone or off-grid applications common in North America, or alternatively to three phase electricity for use in industrial and commercial setting, or single phase in residential setting. The inverter 150 is further configured to apply a sine wave filter, preferably a low-pass filter, to remove the high-frequency components (PWM frequency) from a pulse-width modulated (PWM) signal, resulting in a smoother, more sinusoidal waveform output; as well as an EMI (electromagnetic interference) filter used to remove high-frequency noise r, allowing desired low-frequency signals to pass through while attenuating or blocking high-frequency noise.

Alternatively, the mCHP system 100 according to the present invention may be connected to a power grid but is configured to operate independently in the event of an interruption of electrical supply provided through the power grid.

In yet another alternative embodiment in which the mCHP system 100 is operated while connected to a central power grid, the inverter 150 may direct current from the grid into the engine starter 156 directly, in order to turn the engine 102 over.

In one embodiment of the preset invention, starting the genset 106 is controlled by the microcontroller 101, which allows for a gentler speeding up and starting of the engine 102, thereby reducing fatigue on the engine 102. For example, if the engine 102 is stopped near top dead center of a compression stroke, substantially higher torque would be required to start turning the engine 102 over. The microcontroller 101 may detect the position of the cylinder, for example through the use of a cam sensor, and then reverse the engine 102 approximately ¾ of a cycle, as to reduce the energy required to start the engine near a power stroke.

Referring again to FIG. 1, the current in excess of that needed to charge the battery is made available for use and/or storage. The microcontroller 101 may control inverter 150 to operatively control the speed of the system 100 by way of modulating the electrical load on the genset 106, thereby allowing the engine 102 to operate at maximum power in order to supply maximum heat to the water circuit 132 while operating at any speed within the variable range of the engine 102.

The electrical load placed on the mCHP system 100, through the electrical panel 158 is measured at a current transformer 159. Based on the received signals, the microcontroller 101 may then correspondingly modulate the operating speed of the engine 102 such that the electrical output from the alternator 104 matches the electrical load as detected at the electrical panel 158.

In one embodiment of the present invention, as shown in FIG. 1, the generated electrical current is directed to the building's electrical panel 158, where it can either be used to meet the building's electrical load or provided back to a power grid 160 (if present) when the generated current exceeds the electrical load.

In another embodiment of the present invention in which the mCHP system 100 may or may not be independent of an electrical grid, excess electricity may be stored for subsequent use in a single battery, a battery array, fuel cells, etc.

In yet another alternative embodiment of the present invention (not shown), a mCHP system 100 may provide an electrical output to a plurality of buildings, or discrete units within a single building. By way of example, one or more mCHP systems 100 may provide electricity to a multi-tenant apartment building or multi-tenant office building, where the electricity demand of discrete units is independently metered and provided by the common mCHP system 100. In still another alternative embodiment of the present invention, two or more mCHP systems 100 may operate to provide a combined electrical output sufficient to meet the cumulative electrical load of one or more buildings.

In still another alternative embodiment of the present invention, two or more mCHP systems 100 may operate in tandem to provide a combined electrical output to a plurality of buildings, where the two or more mCHP systems 100 generate a sufficient electrical power to meet the cumulative electrical load of the multiple buildings.

In yet another alternative embodiment, one or more mCHP systems 100 according to an embodiment of the present invention may be integrated into a microgrid, i.e., a decentralized group of electricity sources and loads that may function when disconnected from or entirely independent of a central power grid. The microgrid may comprise a plurality of discrete buildings, where each or many buildings include a corresponding mCHP system 100 as generally described above. By way of one non-limiting example, a subdivision of approximately 100 homes may collectively form a microgrid, with a mCHP system 100 installed at each building or for each of a small group of 2 to 5 homes (depending on the needs of each building). The controllers of the mCHP systems various buildings within the microgrid are in wireless or wired electrical communication with one another, such that the electrical current output from a first mCHP system 100 directly connected with a first building or group of buildings may be transmitted to a second building or group of buildings that is not directly connected to the first mCHP system 100.

In this configuration, the electricity generation of multiple mCHP systems 100 may be distributed to various buildings in the microgrid as to meet the electrical demand of the microgrid system. Such a system may further include additional sources of electrical generation, including solar generated electricity, wind generated electricity, hydrogenated electricity etc. Furthermore, excess electricity generated from the various sources within the microgrid, which exceeds demand, may be stored for subsequent use in a single battery, a battery array, fuel cells, etc. Alternatively, the excess electricity may be sold back to a central power grid, if the microgrid is connected to a central power grid. In such an embodiment, where the microgrid provides multiple sources of electricity generation, the failure of a single source of electricity generation, such as a single mCHP system 100 will not result in either a loss of electricity at the building associated with the mCHP system 100 or a system-wide failure, as the remaining sources of electricity generation throughout the microgrid may be relied upon to provide continued generation and distribution of electricity.

In yet another alternative embodiment, one or more mCHP systems 100 according to the present invention may provide an electrical power supply in combination with one or more additional electrical generation sources, such as solar generated electricity, wind generated electricity, hydrogenated electricity, etc.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A grid-independent micro-combined heat and power system that is configured to provide heat and electrical power to a building, comprising:
a genset comprising a liquid-cooled, variable speed engine and a liquid cooled generator and being configured to output an electrical supply of between approximately between 0.5kW and 40 kW and, more typically, between 1.2 kW and 4.4 kW;
a coolant loop configured to reclaim heat from the genset and; and
a coolant-to-water heat exchanger in thermal communication with the coolant loop and configured to heat water disposed within the water circuit, wherein the power system lacks a connection to an external central power grid.

2. The system of claim 1, wherein the engine of the genset comprises a variable speed engine configured to be modulated between an operating speed of approximately 500 RPM to 5000 RPM and, more typically, 1,200 RPM to 3,400 RPM.

3. The system of claim 2, further comprising a controller configured to regulate the operating speed of the variable speed engine.

4. The system of claim 3, further comprising a sensor disposed within an inverter that generates a signal indicative of a prevailing electrical load on the micro-combined heat and power system, and wherein the controller regulates the operating speed of the variable speed engine in response to the signal indicative of the electrical load.

5. The system of claim 4, wherein the controller is configured to regulate the operating speed of the variable speed engine to generate an electrical output from the alternator that matches the electrical load.

6. The system of claim 4, wherein the controller is configured to regulate the operating speed of the variable speed engine to generate an electrical output from the generator that exceeds the electrical load.

7. The system of claim 6, wherein electrical output in excess of the electrical load is transmitted to an electrical storage device.

8. The system of claim 2, wherein the engine is a dual fuel engine configured to be alternatively fueled by either propane or natural gas without system modification.

9. The system of claim 1, wherein the water disposed within the water circuit receives from 13,000 to 43,000 BTU of heat in the coolant-to-water heat exchanger.

10. The system of claim 1, further comprising a radiator and fan assembly disposed within the coolant loop downstream of the coolant-to-water heat exchanger.

11. The system of claim 1, wherein the water circuit further comprises a storage tank configured to retain a volume of water heated by the coolant-to-water heat exchanger.

12. The system of claim 1, further comprising a battery-powered engine starting system coupled to the engine of the genset.

13. The system of claim 7, wherein the engine starting system comprises an inverter and a battery powered starting motor.

14. The system of claim 1, wherein at least a portion of the electrical supply of between approximately between 1.2 kW and 4.4 kW generated by the genset is provided to an electrical storage device.

15. The system of claim 1, wherein the system is disconnected from any electrical grid.

16. A method of operating the grid-independent micro-combined heat and power system, comprising the steps of:
providing an electrical grid independent genset comprising a variable speed liquid cooled engine and a liquid cooled generator;
using the genset, generating an electrical supply at an electrical output of the generator of between approximately 0.5 kW and 40 kW while modulating the speed of the variable speed engine between a running speed of approximately 500 RPM to 5000 RPM;
heating coolant disposed within a coolant loop from an initial temperature to an elevated temperature via heat transfer from the liquid cooled genset;
passing the heated coolant in the coolant loop through a coolant-to-liquid heat exchanger;
heating a liquid disposed within a liquid circuit at the coolant-to-liquid heat exchanger via heat transfer from the coolant in the coolant loop; and, in response to a signal indicative of electrical demand on an inverter, creating an instruction at a microcontroller to modulate the speed of the engine to at least match electrical current output to electrical demand.

17. The method of claim 16, further comprising the grid-independent micro-combined heat and power system generating an electrical current output in excess of the electrical demand.

18. The method of claim 16, wherein the throttle remains open during engine speed modulation.

19. The method of claim 16, further comprising starting the grid-independent micro-combined heat and power system with a battery-powered engine starting system coupled to the engine of the genset.

20. The system of claim 19, further comprising filtering the output current with a sine wave filter and an electromagnetic interference filter at the inverter.
